(19) United States
(12) Patent Application Publication
(10) Pub. No.: US 2026/0252612 A1
(43) Pub. Date: Aug. 27, 2026

(54) SYSTEMS AND METHODS FOR AN ARTIFICIAL INTELLIGENCE ASSISTANT

(71) Applicant: SuSea, Inc., Palo Alto, CA (US)

(72) Inventors: Yew Siang Tang, Singapore (SG); Thu Minh Nguyen, Ho Chi Minh City (VN); Lim Jun Hong, Singapore (SG); Seng Boon Chin, Singapore (SG); Saahil Jain, New York, NY (US); Bryan McCann, Palo Alto, CA (US); Richard Socher, Palo Alto, CA (US)

(21) Appl. No.: 19/551,475

(22) Filed: Feb. 26, 2026

Related U.S. Application Data
(60) Provisional application No. 63/763,520, filed on Feb. 26, 2025.

(51) Int. Cl. G06F 16/34; G06F 16/3329; G06F 16/3332

(52) U.S. Cl. CPC G06F 16/34; G06F 16/3329; G06F 16/3338

(57) ABSTRACT

Embodiments described herein provide an AI agent to respond to a user query, generate a workflow (and/or chain of thoughts) to generate a work product for the user query, identify data sources to retrieve relevant information for the user query, and generate a final work product (e.g., in a format of a downloadable file) in response to the user query.

### CROSS REFERENCE(S)

This application is a nonprovisional of and claims priority under 35 U.S.C. 119 to U.S. provisional Application no. 63/763,520, filed Feb. 26, 2025, which is hereby expressly incorporated by reference herein in its entirety.

### TECHNICAL FIELD

The embodiments relate generally to machine learning systems for natural language processing, and more specifically to systems and methods for an artificial intelligence (AI) assisted agent to generate a multimodal work product.

### BACKGROUND

Artificial Intelligence (AI) agents often employ a neural network based generative language model such as a large language model (LLM) to generate an output such as in the form of a text response, or a series actions to complete a complex task, such as to network issue troubleshooting, etc. Such a generative language model receives a natural language input in the form of a sequence of tokens, and in turn generates a predicted distribution over a token space conditioned on the input sequence. Generated output tokens over time may in turn form the text response, or actions for completing the task.

However, to use existing LLM-based AI agent to generate a work product (such as a research paper summarizing scientific research experiments), significant human labor is often entailed. For example, conducting a deep research query such as “should we invest in ABC project?” typically involves multiple stages of information gathering, analysis, and synthesis. A user initiating such a query often needs to identify relevant data sources, formulate search parameters, retrieve information from disparate repositories, evaluate the relevance and reliability of retrieved content, organize the collected data into a coherent structure, and then engage an AI agent to generate a written output summarizing findings. Each stage may require iterative refinement based on intermediate results, and the user may need to adjust search queries, expand or narrow the scope of inquiry, and reconcile conflicting information from different sources.

Existing approaches to assembling a research report using generative AI tools require substantial manual intervention at each stage of the research process. Under current methods, a user must manually identify and query individual data sources, review returned results for relevance, copy or transfer relevant content into a working document, prompt a generative language model with specific instructions to summarize or rephrase portions of the retrieved content, manually format retrieved data into tables or charts using separate visualization tools, and assemble the various generated components into a final document format. The user often invest significant time and labor in determining document structure, section ordering, citation formatting, and the integration of textual content with data visualizations.

Therefore, the research workflow is fragmented across multiple discrete tools and interfaces, requiring the user to manually transfer data between systems. Second, the generative language model or the AI agent itself often operates without awareness of the broader research objectives, processing each prompt in isolation without reference to an overarching research plan. Third, the work product creation, such as the generation of data visualizations and formatted document elements, citation management and source verification are still performed largely by manual processes.

### BRIEF DESCRIPTION OF THE DRAWINGS

FIG. 1 illustrates an example operation of an AI agent running on a user device and a server, according to embodiments of the present disclosure.

FIGS. 2A-2C provide an example flow diagram illustrating an example workflow of the AI agent to generate a research report, according to embodiments described herein.

FIGS. 3A-3D provide example UI diagrams of the AI agent illustrating a research process via a client interface of the AI agent client application on a user device, according to embodiments described herein.

FIG. 4 is a simplified diagram illustrating a computing device implementing the AI assistant described in FIGS. 1-3, according to some embodiments.

FIG. 5 is a simplified diagram illustrating a neural network structure, according to some embodiments.

FIG. 6 is a simplified block diagram of a networked system suitable for implementing the AI assistant described in FIGS. 1-5 and other embodiments described herein.

FIG. 7 is an example logic flow diagram illustrating a method of an AI agent executing a task request based on the framework shown in FIGS. 1-6, according to some embodiments.

FIG. 8 is an example logic flow diagram illustrating a method of an AI agent pausing and resuming generation based on the framework shown in FIGS. 1-6, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

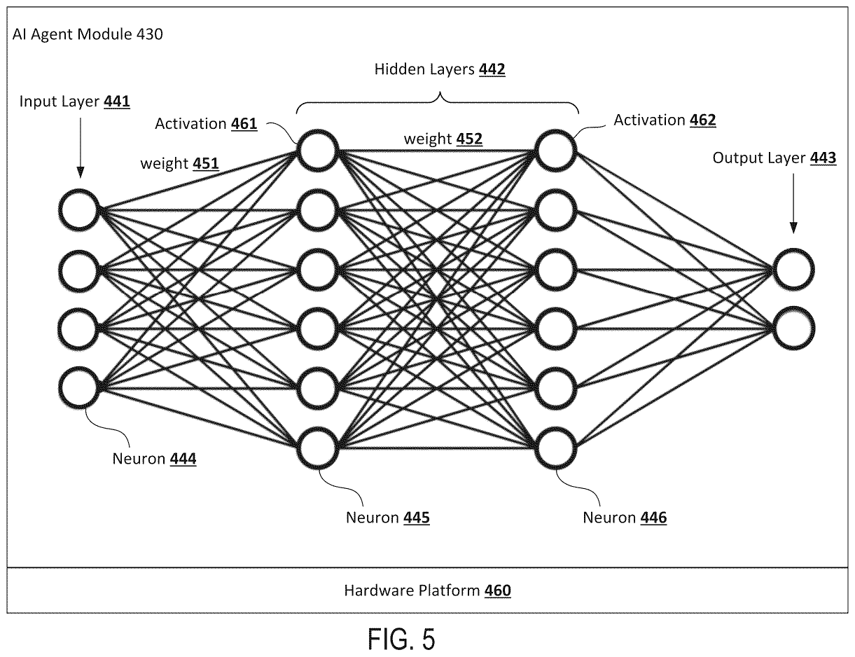

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant number of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Embodiments described herein provide an LLM-based AI agent configured to automate a research process in response to a research query and generate a research report in a form of a downloadable and structured document. For example, in response to a user research query, the AI agent may (i) automatically decompose the query into multiple research objectives, (ii) generate a research plan for each research objective, (iii) perform sequential searches across identified data sources, (iv) generate data visualizations from retrieved information from search, and (v) integrate the generated components into a unified work product in a report format. At each stage (i)-(v), the AI agent may form different system prompts for different sub-tasks. The system prompt is combined with an output from the previous stage to form an input to the LLM to generate reasoning and content.

For example, when the user submits a research query, the AI agent may first operate an underlying LLM with a “decomposition” system prompt to break the query into discrete research objectives. The resulting objectives are stored in memory. Next, the LLM may again be fed a system prompt to generate a structured research plan for each objective. The AI agent may then prompt the LLM with an action-oriented system prompt that enables tool use (e.g., search application programming interfaces (API), model context protocol (MCP) servers, retrieval databases). The LLM may then output structured tool-call instructions a sequential search for each research plan. The searched and/or retrieved data from the sequential search may be then fed back into the LLM, together with a task-specific prompt to generate a visualization specification or executable code of visualization objects.

For instance, the LLM may generate plotting code (e.g., Python/Matplotlib) or structured data to specify a chart schema (e.g., JSON chart configuration) based on the retrieved data. The orchestration layer of the AI agent may execute the plotting code and/or the structured data to produce visualization artifacts (e.g., data plots, charts, SVG, etc.). The AI agent may then synthesize all generated components—text sections, tables, and chart files—programmatically into a structured document using document-generation libraries or APIs (e.g., Markdown-to-PDF converters, DOCX libraries, or PDF rendering engines). The generated document file may take a form as a downloadable file.

In one embodiment, while the AI agent is performing different stages of researching, analyzing, searching, generating and synthesizing the final report, the AI agent may generate and display the workflow via a user interface with full transparency. A user may review the workflow and pause the workflow to interject with revision to the workflow. The AI agent may resume the workflow incorporating user feedback to update the researching and/or generation.

In one embodiment, the AI agent may support state-preserving interruption of an ongoing LLM generation process. For example, upon receipt of a user-issued pause or interruption request at a server, the AI agent may suspend the execution of the research process. At the time of suspension, the AI agent may store one or more intermediate computational states of the AI agent research process, such as the generated research objectives, previously performed search queries, and/or retrieved search data, chart specifications, and state variables associated with the LLM inference session. For example, the AI agent may further store generated output tokens, attention cache data (e.g., key-value tensors corresponding to prior layers), hidden states, and related context variables. The stored state information is maintained in volatile or non-volatile memory and is indexed to the active session, thereby enabling subsequent resumption without reprocessing the entire prompt sequence. In this manner, partial generation progress is preserved while temporarily halting further token emission.

In one embodiment, the AI agent may enter a feedback integration loop configured to receive additional user input. Upon receiving supplemental instructions (e.g., to modify research scope, to specify a desired format for the chart, etc.), the AI agent may evaluate a resuming point in the workflow where the new input may impact, e.g., whether to initiate a new research workflow or revision of the ongoing workflow. If a new research project is determined, the previously stored state information of the prior research process including all LLM states may be discarded, and the newly provided input may be used to generate updated research objectives and associated outputs. If revision of the existing workflow is determined, the newly received input tokens are combined with the preserved session state and provided to the LLM as extended context, enabling continued autoregressive generation from the prior interruption point. In some embodiments, the system further permits multimodal feedback injection during the paused state, including user-provided charts, images, structured datasets (e.g., spreadsheet files), or other artifacts. Such multimodal inputs may be encoded into structured representations and incorporated into the resumed generation process to modify planning, analysis, visualization, or report synthesis operations.

In this way, the AI agent provides an integrated pipeline that executes the research workflow within a unified system with minimized or little manual labor. The generative language model maintains context of the overarching research objectives throughout the execution of discrete operations, reducing fragmentation and manual intervention requirements. The coordination of text generation, data visualization, and document formatting within a single pipeline reduces data transfer errors and improves consistency in the generated output. Generation efficiency of AI agent is thus improved.

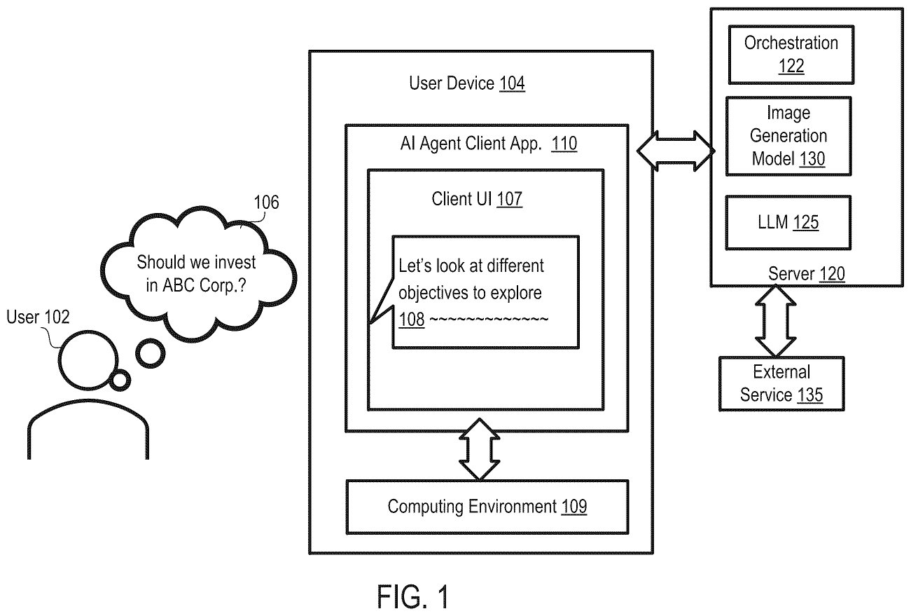

FIG. 1 illustrates an example operation of an AI agent running on a user device and a server, according to embodiments of the present disclosure. In one embodiment, an AI agent may comprise a set of software and/or hardware that processes information from its environment and takes action to achieve specific goals such as executing a task. For example, an AI agent may comprise a client-side component such as an AI client application 110 running on a computing environment 109 of a user device 104, and a server-side component such as an orchestration layer 122, a multimodal LLM 125 and/or an image generation model 130 (such as a diffusion model, etc.) hosted on a server 120.

In one embodiment, the computing environment 109 on the user device 104 may further host different types of applications and/or processes such as a browser 111, and various desktop software applications. Example software applications may comprise a communications application (such as email, texting, voice, social networking, and IM applications that allow a user to send and receive emails, calls, texts, and other notifications), other applications (such as device interfaces and other display modules that may receive input and/or output information, software programs for text or image/video editing, document processing, spreadsheet processing, file management, and/or the like, executable by a processor, including a graphical user interface (GUI) configured to provide an interface), and/or the like.

In one embodiment, the computing environment 109 may correspond to an isolated environment such as a virtual machine, a sandbox application, and/or the like. In this way, the AI agent client application 110 may save data within the isolated environment isolated from other components of the user device 104 for security protection.

In one embodiment, an AI client application 110 may be implemented on a user device 104 to receive a user task request 106 (such as a research query of “should we invest in ABC, Corp.?”) as a natural language input typically through a client UI 107 which may include a chat or command interface. This user task request 106 may range from simple queries to more complex tasks like data analysis, automation, or even generating content. For example, a user operating user device 104 may enter a user utterance, e.g., via text or audio input, such as a question, uploading a document, and/or the like via the client UI 107.

In some embodiments, the AI client application 110 may be deployed as a standalone desktop application on the user device 104, providing a dedicated interface for users to interact with the AI agent. Alternatively, the client application may be seamlessly integrated within other software environments, such as a word editing application, an image editing application, an integrated development environment (IDE), or similar productivity tools. In these integrated scenarios, the AI client application 110 may operate in the background, continuously monitoring the user's editing or coding activities within the host application. For example, while a user is drafting a document in a word processor or writing code in an IDE, the AI client application 110 can analyze the ongoing work in real time, proactively offering suggestions, corrections, or automated actions relevant to the current context.

In some embodiments, the client UI 107 may take various forms depending on the context of the application. For instance, the client UI 107 may comprise a chat interface that allows the user 102 to enter a user task request 106 in natural language, facilitating conversational interactions with an AI agent. In another example, the client UI 107 may be implemented as a command line interface, enabling users 102—such as developers—to input coding requests or execute specific commands directly within their development environment. Additionally, the client UI 107 may be realized as an integrated widget embedded within another application, such as a word processing application, an image editing application, an IDE, and/or the like. In this configuration, the widget may automatically analyze user activities and proactively suggest next-step actions or requests, such as a code completion suggestion, content suggestions that may form a user task request 106 upon user approval.

For example, the user 102 may provide a user task request 106 of “should we invest in ABC Corps?” to the AI client application 110. The AI client application 110 in turn sends the user task request 106 to the server 120 that hosts a multimodal LLM 125. For example, the user task request 106 may be transmitted via a HTTPS message. In some implementations, the AI client application 110 may retrieve relevant local information (e.g., user information from a user database, user conversation history, etc.), and combine the retrieved local information with the user task request 106 in an input prompt to be sent to the server 120.

In one embodiment, the server 120 may host one or more neural network models such as a multimodal LLM 125, an image generation model 130, and/or the like, and implement orchestration software 122 control how various neural network models and external tools work together to complete a task. For example, the orchestration software 122 may form an input prompt to the LLM 125, containing tool definitions for external tools, and the LLM 125 may in turn generate structured outputs as function calls for the eternal service 135, such as to perform an Internet search, to invoke a specific application (e.g., document synthesizing, PDF generation, etc.).

The multimodal LLM 125 may perform answering, reasoning and decision-making tasks. An input to the multimodal LLM 125 may comprise the user task request 106, retrieved local relevant information from the user device 104, and/or an instruction provided the multimodal LLM 125 to guide its behavior or responses in a particular way, referred to as a “system prompt.” For example, the system prompt may contain instruction for the multimodal LLM 125 to analyze the input and respond according to the request identified in the input, and generate an output in a certain format, e.g., suggested code program, text description, etc. The multimodal LLM 125 may in turn generate a response 108 based on an input combining the user task request 106 and any system prompt. Additional details on the multimodal LLM 125 generating the response 108 may be described in FIG. 5.

In one embodiment, the response 108 may include instructions, explanations, code scripts or direct actions to address the user task request 106. Such response 108 may be displayed via the client UI 107 for transparency. In addition to the response 108 that describes how to fulfill the user task request 106, the multimodal LLM 125 may generate computer-executable commands (e.g., system-level commands, Python scripts, etc.) that may directly trigger actions and/or interactions with the computing environment 109 on the user device 104.

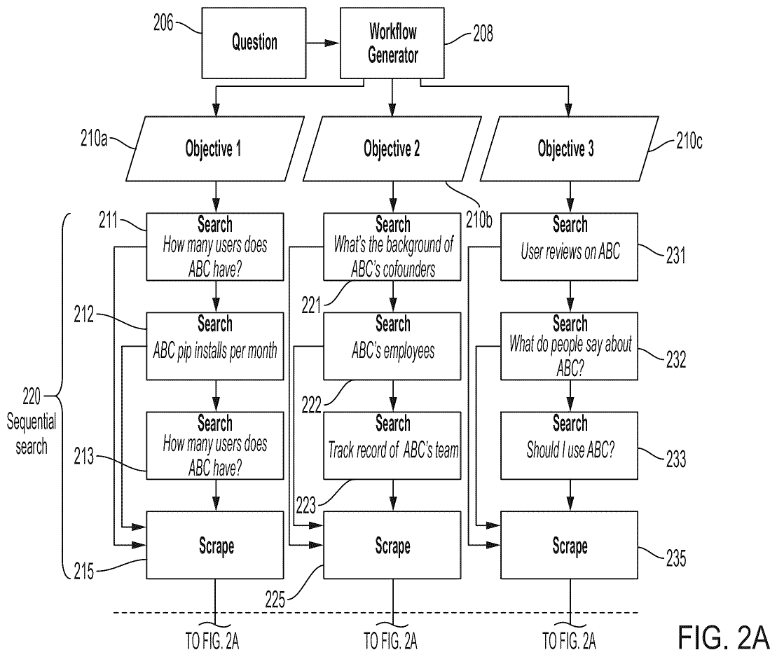

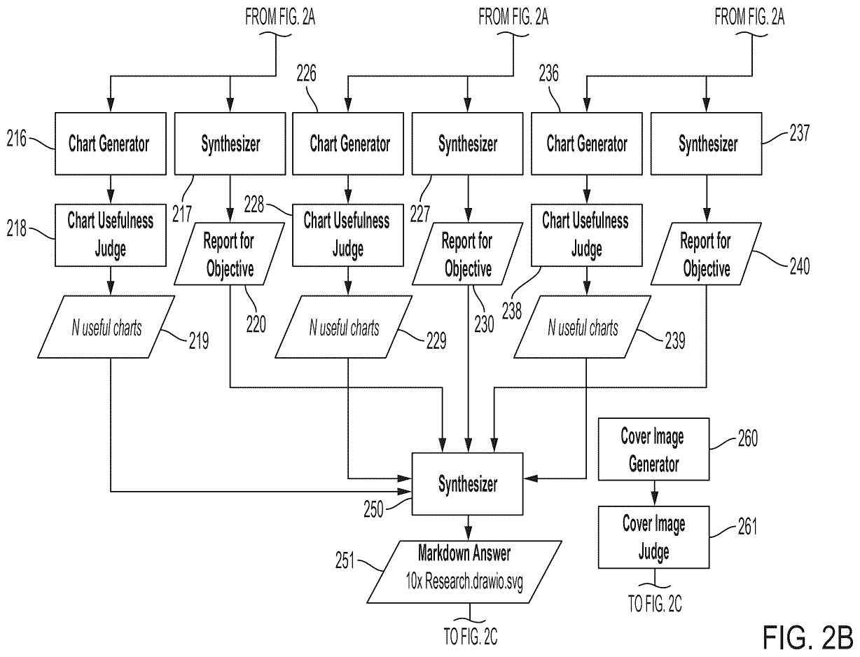

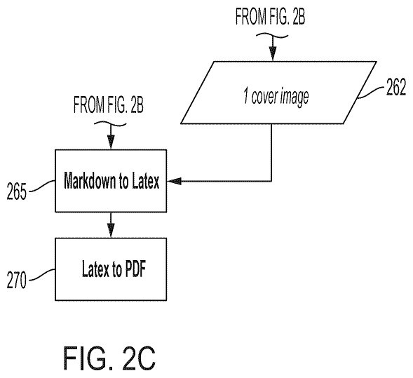

For example, in response to a user task request 106 such as “should we invest in ABC Corp.,” the AI agent may not only employ the multimodal LLM 125 to generate the text response 108 describing how to perform the research and what is the research finding via the client UI 107 in a chat format. The AI agent may employ multiple submodules and or external services 135 to research, search, generate various data artifacts, and synthesize a downloadable report for the user, as described in FIGS. 2A-2B.

FIGS. 2A-2C provide an example flow diagram illustrating an example workflow of the AI agent to generate a research report, according to embodiments described herein. An AI agent may generate and execute a multi-stage AI agent workflow designed to generate a comprehensive research report in response to a user query 206. As shown in FIGS. 2A-2B, various submodules of the AI agent may be illustrated to perform and/or execute different functions such as a work flow generator 208 to decompose the research question 206 into research objectives 210a-c, sequential searches 220 to perform searches, chart generator 216, 226, 236 to generate chart artifacts, data synthesizer 217, 227, 237 to organize textual analysis and figure references into a structured document format, and/or the like. Here, each “submodule” may be implemented as a specific system prompt guiding the LLM (e.g., 125 in FIG. 1) to generate specific structured format, e.g., a “generate-workflow” prompt that instructs the LLM to output structured research objectives, a “search” system prompt augmented with tool definitions that enable the LLM to produce structured tool calls for external search APIs, a chart generation prompt instructing the LLM to generate chart specifications or executable plotting code from raw data, etc. The “submodule” may be further implemented as a tool-enabled interface to invokes external services to perform deterministic operations, such as to send LLM-generated chart specification and/or structured data (e.g., JSON chart specifications, plotting code, Markdown/HTML report content, or a document schema, etc.) to APIs to forward to external services, such as relevant application servers. The application servers may then programmatically convert the LLM-generated data into and thus return concrete artifacts, such as a PNG/SVG chart image or a compiled PDF file —using rendering libraries or document compilers.

For example, a user may submit a research question 206—in this example, “Should I invest in ABC Corp?”—which may be passed to a workflow generator module 208 to decomposes into discrete research objectives. The workflow generator module 208 may parse the initial query 206 into a plurality of distinct objectives 210a-c, such as assessing ABC Corp's traction, evaluating the team's background, gathering user reviews, and/or the like. Each objective 210a-n may be subsequently addressed through a structured research plan involving multiple targeted searches and web scraping operations.

In one embodiment, the AI agent may generate a few clarification questions for a user to provide answers. The user generated answers may then be incorporated into the prompt for the workflow generator module 208 to generate the research objectives 210a-n. The AI agent may iteratively generate clarification questions for the user to provide answers to guide a next step generation.

In one embodiment, for each research objective 210a-n, the AI agent may execute a series of parallel search queries to gather relevant data. For instance, for the first research objective 210a to evaluate ABC Corp's traction, the AI agent conducts sequential searches 220 on user counts 211, pip installation statistics per month 212, and overall user base metrics 213. Similarly, for the second research objective 210b to gather team information, the AI agent may perform sequential searches 220 on cofounder backgrounds 221, employee information 222, and the team's track record 223, and/or the like. For the research objective 210c of user sentiment, the AI agent may conduct sequential searches 220 on user reviews 231, user word-of-month opinions 232, and user sentiment on the utility of ABC Corp. 233.

In one embodiment, the AI agent may performs these searches 211-213, 221-223, 231-233 via a structured interplay between the LLM 125 and external tools. For example, when a research objective 210a-c is identified, the orchestration layer of the AI agent may feed the LLM an action-oriented system prompt that enables tool use. The LLM may generate a structured output indicating a search request 211-213, 221-223, 231-233, respectively, e.g., in a JSON script format. The structured output may specify a function call that is transmitted to a search API of a search engine. The search API may in turn return a set of search results (e.g., URLs, snippets, and metadata). In some embodiments, the orchestration layer of the AI agent may also leverage Model Context Protocol (MCP) servers or other tool-integration frameworks to conduct communication between the LLM and external services.

Once the search results are retrieved, the AI agent may invoke additional function calls—such as ‘scrape_page(url=“ . . . ”)—for scraping services 215, 225, 235 to extract full-text content from web pages in the search results. The retrieved data is then fed back into the LLM's context window, enabling the model to either refine its search strategy with follow-up queries or proceed to synthesize findings.

For example, the AI agent may also conduct sequential searches 220 to progressively deepen its understanding of a research objective 210a-c. For example, the LLM may generate an initial search query 211 based on the research objective 210a, and the orchestration layer of the AI agent may execute the query 211 and retrieves results. These results—including snippets, extracted text, and metadata—are then appended to the a context window (up to a maximum window size) along with a follow-up prompt instructing the LLM to identify information gaps or areas requiring further exploration. Based on this analysis, the LLM generates a refined or entirely new search query 212 designed to address the identified gaps. For example, if the first query 212 returns only partial data, the LLM may recognize the need for more granular metrics and generate a second query 212. This iterative cycle continues—with each round of search results informing the next query—until the AI agent determines that sufficient information has been gathered, or a predefined maximum number of iterations (e.g., three search rounds) has been reached. This sequential refinement process allows the AI agent to adaptively explore each research objective 210a-c, progressively narrowing in on the most relevant and comprehensive data rather than relying on a single static query.

In one embodiment, the AI agent may parse webpages from searched results to obtain search results data. The AI agent may utilize an LLM to generate a summary of bullet points and/or facts extracted from web sources as search results data for the next-step generation and/or synthesis, instead of the entirety of text scaped from each webpage.

In one embodiment, with reference to FIG. 2B, once data is retrieved, the workflow proceeds to a synthesis stage where the findings from each respective research objective are compiled. The scraped data from scrape modules 215, 225, 235 may be respectively fed to a chart generator 216, 226, 236 and/or a synthesizer 217, 227, 237. For example, the synthesizer component 217, 227 and 237 may be configured to generate a Markdown-formatted answer as a report for each objective 220, 230 or 240, based on an input of the scraped data.

In one embodiment, the AI agent may iteratively conduct the search and generation process. For example, the AI agent may generate a set of objectives 210a-c, observes the search results from the sequential search 220, and update the research plan for the next turn-this may be iteratively updated to improve research plan performance.

In one embodiment, the AI agent may execute a computation workflow that applies analytical operations to data collected during the research process. For example, the orchestration layer of the AI agent may invoke a computation module configured to process raw data retrieved from sequential searches (e.g., 211-213, 221-223, 231-233) according to computation workflow objectives derived from the research objectives (e.g., 210a-c). The computation workflow objectives may specify data transformation operations, statistical analyses, trend calculations, comparative metrics, and other complex data processing tasks. The generative language model may generate executable code (e.g., Python scripts utilizing NumPy, Pandas, or SciPy libraries) or structured computation specifications that define the analytical operations to be performed on the retrieved datasets. The orchestration layer may execute such code in a sandboxed environment to produce computed results, which are then fed back into the LLM context for chart generation and report synthesis.

In one embodiment, the chart generator 216, 226 and 236 may each select and generate, based on the scraped data, data visualization artifacts (such as tables, charts, data plots, and/or the like) for each research objective. For example, the retrieved and synthesized data may be fed into the LLM along with a task-specific prompt for chart generation instructing the LLM to produce visual representations of the input data. The LLM may output executable plotting code—such as Python scripts utilizing libraries like Matplotlib, Seaborn, or Plotly—or alternatively generate structured data specifications in formats like JSON or YAML that define chart schemas (e.g., chart type, axes labels, data series, color schemes, etc.). The orchestration layer of the AI agent may then execute the plotting code in a sandboxed environment or parse the structured specifications through a rendering engine to produce the final visualization artifacts, which may include bar charts, line graphs, pie charts, scatter plots, or tabular summaries, and/or the like. In this way, the LLM may dynamically select the most appropriate visualization type based on the nature of the underlying data—for instance, choosing a time-series line chart for trend data or a comparative bar chart for categorical metrics—thereby ensuring that the generated visuals effectively communicate insights to the end user.

In one embodiment, the generated visualization artifacts may each be verified and/or reviewed at the chart usefulness judge 218, 228 or 238. For example, the chart usefulness judge 218, 228 or 238 may employ a system prompt instructing the LLM to review whether the generated visualization artifacts may be helpful in illustrating the underlying data. For another example, the chart usefulness judge 218, 228 or 238 may provide a user interface element to display the generated visualization artifacts for a user to review and approve. The user may provide feedback by entering text instructions to revise, and/or re-generate the visualization artifacts, such as to specify a specific type of artifact, to change the data range, to modify the color or format, and/or the like.

In one embodiment, the AI agent may employ the synthesizer 250 to assembles all synthesized components including the visualization artifacts (charts) 219, 229, 239, and the reports 220, 230, 240 into a structured output, such as a Markdown answer 251. For example, the LLM is prompted with a synthesis-oriented system prompt along with all the accumulated components: the textual reports 220, 230, 240 addressing each research objective, references to the selected chart files, structured data for the charts 219, 229, 230, and/or the like. The LLM then generates a structured Markdown document that integrates these elements into a unified structured output 251, which may include hierarchical section headers (e.g., #Executive Summary”, “## Traction Analysis”, and “### User Growth Metrics”), prose paragraphs summarizing key findings, embedded charts references using Markdown syntax (e.g., “! [charts]”, etc.), tables for comparative data, and inline formatting such as bold text for emphasis or bullet points, and/or the like. This Markdown-formatted output 251 serves as an intermediate representation that preserves both the logical structure and the visual elements of the report.

In one embodiment, in addition to LLM processing, the AI agent may comprise an image generation model 260, which may generate a cover image in response to a text input of the research question 206. The generated image 261 may be approved by a judge 261, such as a multimodal LLM judge and/or human review.

In one embodiment, the Markdown output 251 together with the approved cover image 262 may be combined and converted to LaTeX format 265 and then rendered as a PDF 270. For example, the orchestration layer of the AI agent may invoke external document-generation tools, such as Pandoc (a universal document converter), dedicated Markdown-to-LaTeX libraries, or PDF rendering engines—to programmatically transform the Markdown content into LaTeX format. These tools may parse the Markdown syntax, map it to corresponding LaTeX commands (e.g., converting Markdown headers to LaTeX section commands, translating image references to includegraphics statements, and reformatting tables into LaTeX tabular environments), and produce a compilable LaTeX document. The orchestration layer of the AI agent may then send the LaTex file 265 to a LaTeX compiler (e.g., pdflatex or xelatex) to render the LaTeX source into a final PDF file 270.

In one embodiment, the final PDF file 270 may take a form in markdown and pdf format. The PDF file may comprise a title page and introduction section, wherein the title page may include the research query as a heading, metadata such as generation timestamp and data source summary, and the introduction may comprise an executive summary synthesizing key findings from across all research objectives. The full report content may be organized according to the discrete research objectives 210a-c, wherein each section may include synthesized textual analysis, supporting data, and inline citations referencing original data sources, and wherein citations may be formatted as hyperlinked references enabling verification of source material. One or more charts rendered as embedded image files (e.g., PNG, SVG, or other image formats) within the PDF document, wherein the visualization artifacts generated by the chart generator modules (e.g., 216, 226, 236) are programmatically inserted at appropriate locations within the document structure corresponding to their associated research objectives. A cover image generated using a generative AI image model (e.g., a diffusion model or other text-to-image generation model 260 as described herein), wherein the cover image may be generated based on the research task request and may be positioned on the title page or as a header element within the PDF to provide a visually representative illustration of the research subject matter.

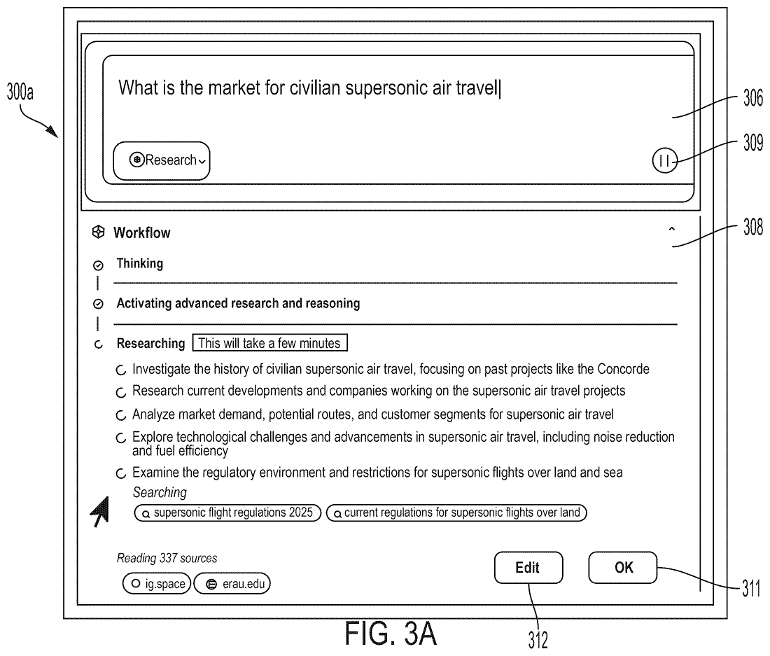

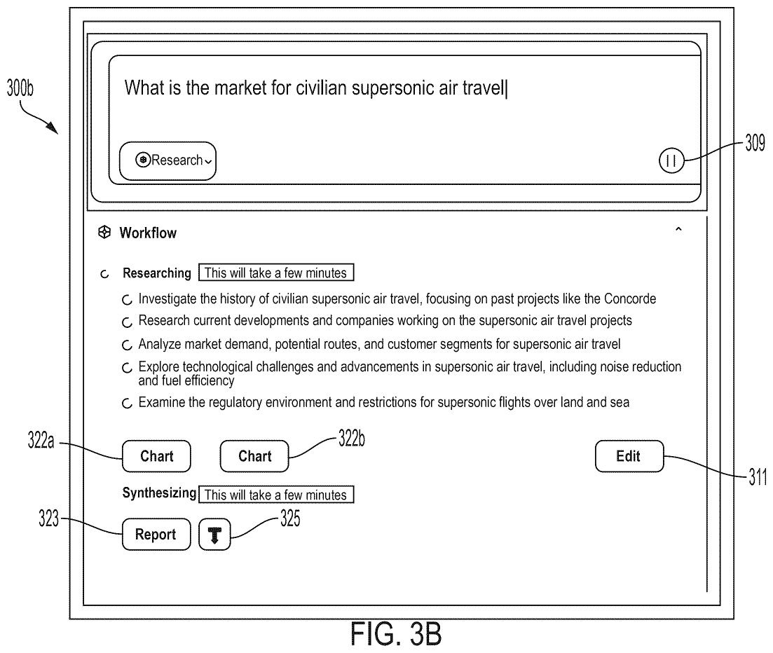

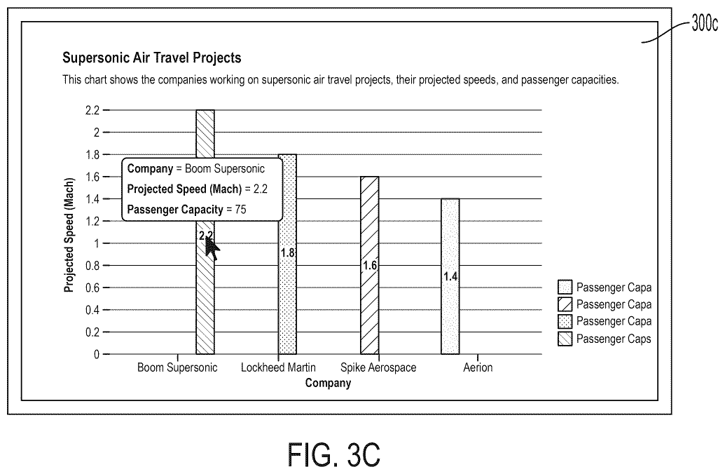

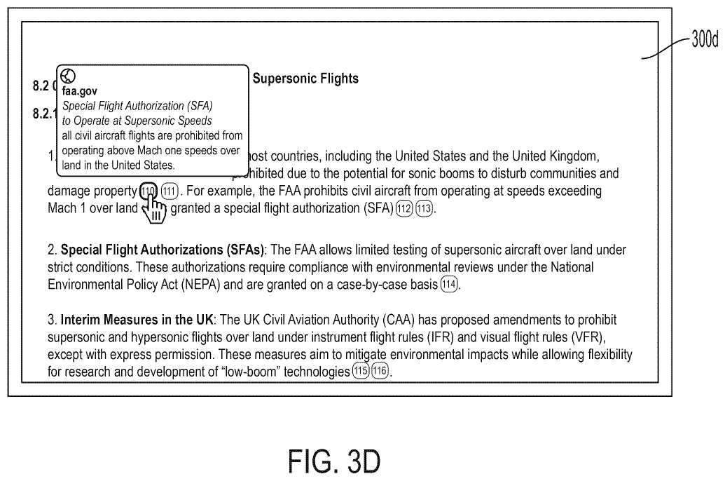

FIGS. 3A-3D provide example UI diagrams of the AI agent illustrating a research process via a client interface of the AI agent client application on a user device, according to embodiments described herein. The UI diagram 300a may comprise a query input area where a user enters a research query 306—in this example, “What is the market for civilian supersonic air travel.” The user may manually select the “research” button to trigger the AI agent to initiate a research workflow. Alternatively, the AI agent may automatically determine whether to trigger the research workflow based on the query 306.

Upon submission, the AI agent may display its thinking process 308 in real time, showing the user the various stages of research activity in response to the research query 306. The interface indicates that the AI agent is “Reading 337 sources” and displays the current search query being executed (e.g., “supersonic flight regulations 2025”). The thinking process panel 308 enumerates the discrete research objectives the AI agent has identified, such as examining the regulatory environment and restrictions for supersonic flights, exploring technological challenges and advancements including noise reduction and fuel efficiency, analyzing market demand and potential customer segments, researching current developments and companies working on supersonic projects, and investigating historical context such as the Concorde.

The interface also provides interactive controls that enable user feedback injection during the research process. For example, upon identifying and displaying the research objectives in response to the research query 306, the interface may provide an “Edit” button 312 allowing the user to modify or refine the current search query or research objective before the AI agent proceeds, and an “OK” button 311 confirms that the user approves of the proposed research objectives. Alternatively, the AI agent may implement a timer control on collecting user feedback for the research objectives, e.g., if no user feedback, either “edit” or “OK” is received within a pre-defined amount of time (e.g., 10 sec, 15 sec., etc.), the AI agent may assume the user agree with the current progress and proceed to the next stage. Similar user feedback mechanism may be implemented at different stage of the research process, e.g., at research objective generation (e.g., 210a-c in FIG. 2), at each stage of sequential searches (e.g., 211, 212, 213 in FIG. 2), at chart generation stage (e.g., 218, 228, 238 upon user reviewing the generated charts, etc.), and/or the like.

Additionally, a pause button 309 may allow the user to manually stop or pause the research process at any point, providing granular control over the agent's execution and allowing the user to intervene if the research direction needs adjustment.

With reference to UI diagram 300b, the generated artifacts (e.g., charts 219, 229, 239 in FIG. 2) may be presented to the user as user-engageable artifact thumbnails 322a-b, allowing the user to select any individual visualization to view it in an expanded preview panel. The “Edit” button 311 may allow the user to provide feedback or request modifications—such as changing the chart type, adjusting axis labels, modifying color schemes, or requesting that different data points be emphasized—whereupon the AI agent regenerates the visualization according to the user's specifications. For example, upon a user clicking on one of the user-engageable artifact thumbnails 322a-b, an example chart may be presented, similar to that shown at diagram 300c in FIG. 3C

For example, if a user “pauses” the generation process and provide feedback such as “re-generate the chart to show data range from last year,” the AI agent already has stored state from prior steps—including the research plan, retrieved datasets, previously generated chart specifications, and possibly the transformer KV cache of the LLM. The orchestration layer of the AI agent may append the user feedback as a new instruction in the conversation context and invokes the relevant submodule (e.g., the chart generator 216, 226, 236 in FIG. 2) to resume the workflow. The AI agent may thus retrieve the previously stored dataset and prior chart configuration (e.g., JSON spec or plotting code), then call the LLM again with: (1) the original chart spec, (2) the underlying data reference, and (3) user feedback to generate “to show data range from last year.” The LLM outputs an updated structured chart specification reflecting the “last year” filter. That updated spec is sent to the chart-rendering service, which deterministically regenerates the image artifact. The rest of the workflow (report synthesis, PDF assembly) may remain unchanged unless further modification is requested. In this way, the AI agent may resume picks up where it left off” by relying on persisted state and modular re-execution of only the affected component.

The UI diagram 300b may present the final assembled report as a prominent clickable element 323, which the user can select to view the complete document in a reading pane within the interface. For example, upon a user clicking on the report button 323, an example preview of the final report may be presented, similar to that shown at diagram 300d in FIG. 3D. The report may comprise citations such as “[112], [113]” that are user engageable widget for a user to click and redirect to the webpage that provide original content to support the generated text.

In some implementation, as shown in UI diagram 300d, when a user places the mouse on the citation mark “[110]”, a UI widget such as a pop-up window may automatically display the original data source of the citation, and a quote from the original data source to verify the information presented in the segment of the generated text. If the user clicks the link to access the webpage of the original data source, the user may be automatically directed to the section containing the quote, which may be highlighted, on the webpage. In this way, the user may locate and thus verify the accuracy of the generated text with the original data source in an efficient manner. User experience using the AI-assisted writing tool is improved.

The UI diagram 300b may further comprise a “Download” button 325 accompanies the report preview, enabling the user to export the fully rendered research report as a downloadable PDF file for offline access, sharing, or archival.

### Computer and Network Environment

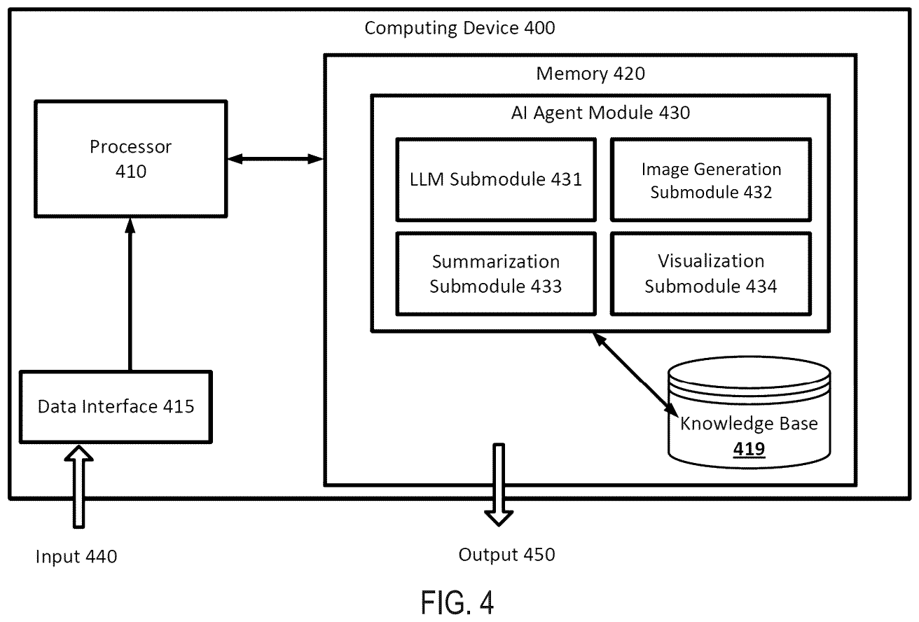

FIG. 4 is a simplified diagram illustrating a computing device implementing the AI agent described in FIGS. 1-3, according to some embodiments. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine. In one embodiment, the processor 410 may be recited in a singular or plural form to refer to one or more processors of different types—for example, a collective unit of GPUs, TPUs, CPUs, and/or the like.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on the same board, in the same package (e.g., system-in-package), on the same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI agent module 430 that may be used to implement and/or emulate the systems and models, and/or to implement any of the methods described further herein. AI agent module 430 may receive input 440 such as an input training data (e.g., documents or code snippets from fiction, papers, arxiv, wikipedia, codebases, and/or the like) via the data interface 415 and generate an output 450 which may be a response to the input, such as an answer to a question, an action manual, a programming code segment, and/or the like.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a query 206, from a user via the user interface.

In some embodiments, the AI agent application module 430 may comprise a client application, or LLM and a server-side software interacting with an LLM. The AI agent application module 430 may comprise one or more neural network models (e.g., LLM 125 shown in FIG. 1), and additional software operated with the neural network models, such as to preprocess an input to the neural network models, to call an external function, to post-process an output from the neural network models, and/or the like.. The AI agent application module 430 may be implemented on a combination of different types of hardware such as the processor 410 and one or more GPUs or TPUs 532a-n. For example, the LLM (e.g., multimodal LLM 125 in FIG. 1) computational workload to generate output tokens representing a text response and/or an executable code may be distributed across multiple GPUs to accelerate both training and inference. Additional details of the computational workload of a neural network model may be described in FIG. 5.

For another example, the AI agent application module 430 may formulate one or more input prompts to the multimodal LLM, receive and process execution results (e.g., by the orchestration software 122 in FIG. 1), and/or the like. At least some of these operations may be performed by the processor 410, such as a CPU to execute one or more computer-executable instructions retrieved from the memory 420.

In some embodiments, the AI agent module 430 is configured to generate a response to a user query in a wide variety of applications. The AI agent module 430 may further include LLM submodule 431 (e.g., similar to 125 in FIG. 1), an image generation submodule 432 (e.g., 130 in FIG. 1), a summarization submodule 433, and a visualization submodule 434. In one embodiment, the memory 420 may further store a knowledge base 419, e.g., storing a collection of documents, context history, and/or other context information.

Some examples of computing devices, such as computing device 400 may include non-transitory, tangible, machine readable media that include executable code that when run by one or more processors (e.g., processor 410) may cause the one or more processors to perform the processes of the method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the AI agent module 430 described in FIG. 4, according to some embodiments. In some embodiments, the AI agent module 430 and/or one or more of its submodules 431-434 may be implemented at least partially via an artificial neural network structure shown in FIG. 5. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a user query, a selected relevant document, a chunk, and/or the like. The number of nodes (neurons) in the input layer 441 may be determined by the dimensionality of the input data (e.g., the length of a vector of an input prompt combining a context and a user query). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the AI agent module 430 receives an input 440 of a query and transforms the input into an output 450 of a response. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include, but are not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer based LLM, and/or the like.

In one embodiment, the AI agent module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, into encoded representations representing a high-dimensional embedding of the tokens. Such encoded representations capture various linguistic features and relationships among the tokens. The self-attention and feed-forward operations are iteratively performed through multiple layers of self-attention and feedforward layers, thereby generating an output based on the context of the input tokens. One forward pass for an input token to be processed through the multiple layers to generate an output in a Transformer architecture often entails hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI agent module 430 and its submodules 431-434 may be implemented by hardware, software and/or a combination thereof. For example, the AI agent module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-434 and/or any other neural network models hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the AI agent module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based AI agent module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as data samples from datasets of fiction, papers, arxiv, wikipedia, codebases are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding give an example of ground truth label) from the training data, to compute a loss function that measures the discrepancy between the predicted output and the expected output. For example, the loss function may be cross entropy, minimum mean square error (MMSE), and/or the like. Given the loss, the negative gradient of the loss function is computed with respect to each weight of each layer individually. Such a negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network-based AI agent module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

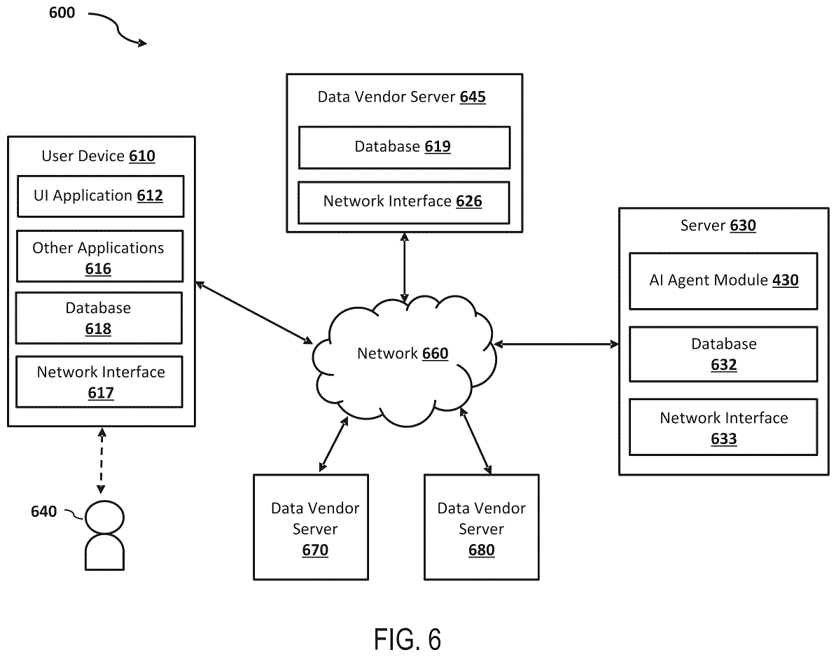

In one embodiment, AI agent module 430 and its submodules 431-434 may be housed at a centralized server (e.g., computing device 400) or one or more distributed servers. For example, one or more of AI agent module 430 and its submodules 431-434 may be housed at external server(s). The different modules may be communicatively coupled by building one or more connections through application programming interfaces (APIs) for each respective module. Additional network environments for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as identifying an IT anomaly, generating a code snippet to solve a problem, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI assistance in solving problems such as code generation and debugging, IT support, and/or the like.

FIG. 6 is a simplified block diagram of a networked system suitable for implementing the AI bot described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a visualized response (e.g., 105 in FIG. 1) from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 430 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 430 may generate a response via the process described in FIGS. 1-5. The AI agent module 430 may thus cause a display of the response at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the response.

User device 610 may further include database 618 stored in a transitory and/or non-transitory memory of user device 610, which may store various applications and data and be utilized during execution of various modules of user device 610. Database 618 may store a user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets to the server 630. The database 619 may be implemented by one or more relational databases, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 430 and its submodules described in FIG. 4. In some implementations, AI agent module 430 may receive data from database 619 at the data vendor server 645 via the network 660 to generate a response. The generated response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the AI agent module 430. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Workflows

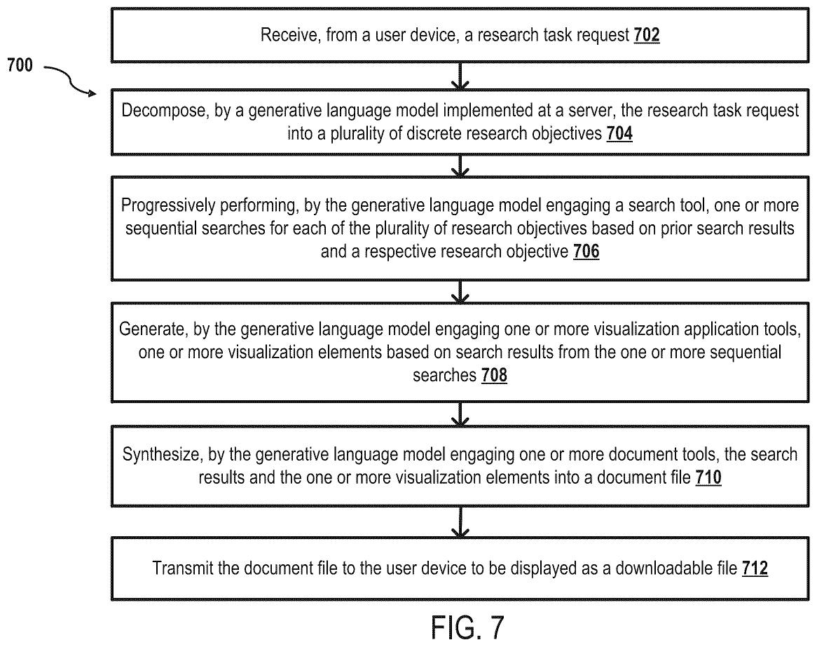

FIG. 7 is an example logic flow diagram illustrating a method of an AI agent executing a task request based on the framework shown in FIGS. 1-6, according to some embodiments. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 430 (e.g., FIGS. 4-6) that performs contextual response generation in response to a query.

As illustrated, the method 700 includes a number of enumerated steps, but aspects of the method 700 may include additional steps before, after, and in between the enumerated steps. In some respects, one or more of the enumerated steps may be omitted or performed in a different order.

At step 702, the method 700 may comprise receiving, from a user device (e.g., 104 in FIG. 1), a research task request (e.g., 106 in FIG. 1).

At step 704, the method 700 may comprise decomposing, by a generative language model (e.g., LLM 125 in FIG. 1) implemented at a server (e.g., 120 in FIG. 1), the research task request into a plurality of discrete research objectives (e.g., 210a-c in FIG. 2A).

At step 706, the method 700 may comprise progressively performing, by the generative language model engaging a search tool, one or more sequential searches (e.g., 220 in FIG. 2A) for each of the plurality of research objectives. Each of the one or more sequential searches is based on prior search results and a respective research objective.

At step 708, the method 700 may comprise generating, by the generative language model engaging one or more visualization application tools, one or more visualization elements (e.g., charts 219, 229, 239 in FIG. 2B) based on search results from the one or more sequential searches. For example, the generative language model may generate one or more structured data specification for the one or more visualization application tools to render the one or more structured data specification into the one or more visualization elements.

At step 710, the method 700 may comprise synthesizing, by the generative language model engaging one or more document tools, the search results and the one or more visualization elements into a document file (e.g., 270 in FIG. 2C). For example, a text description of a workflow of the decomposing, the one or more sequential searches, generation of the one or more visualization elements, or the synthesizing to cause the text description of the workflow may be progressively displayed at a user interface on the user device. For another example, the method 700 may further comprise generating, by a text-to-image generation model, a cover image (e.g., 262 in FIG. 2B) from the research task request. The generative language model may then generate a structured document format combining a text section, the one or more visualization elements, and the cover image. The structured document format may then be converted to the document file using a document rendering engine.

At step 712, the method 700 may comprise transmitting the document file to the user device to be displayed as a downloadable file (e.g., 323 in FIG. 3B).

In one embodiment, throughout steps 702-710, the method 700 may further comprise presenting, by the AI agent, check-in and/or follow up questions via a user interface (e.g., client UI 107 in FIG. 1). For example, at step 702 but before step 704, the AI agent may present questions for a user to provide answers in order to generate research objectives. For another example, at step 704 but before step 706, the AI agent may present questions for a user to provide answers to approve, or refine the generated research objectives. For another example, throughout step 706 and/or before step 708, the AI agent may constantly ask user questions to confirm and/or approve the progress, intermediate search results, and/or the like of the sequential searches. For another example, throughout step 708 before step 710, the AI agent may present the generated visualization elements for a user to review and approve. In one embodiment, the AI agent may set a pre-defined time period (e.g., 10 seconds, 15 seconds, etc.) for the user to provide confirmation and/or any additional input to revise. The AI agent may proceed to the next step if no user feedback is received within the pre-defined time period.

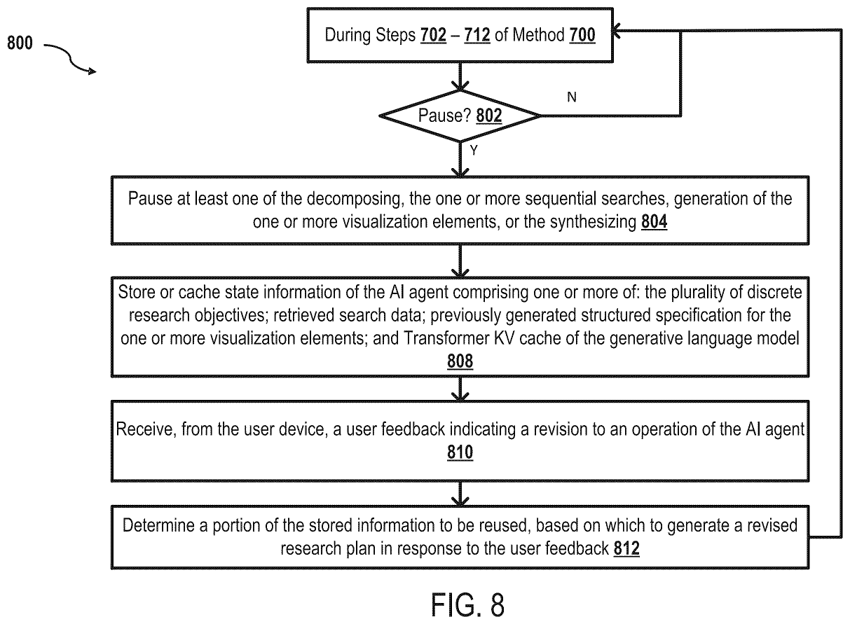

FIG. 8 is an example logic flow diagram illustrating a method of an AI agent pausing and resuming generation based on the framework shown in FIGS. 1-6, according to some embodiments. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 430 (e.g., FIGS. 4-6) that performs contextual response generation in response to a query.

As illustrated, the method 800 includes a number of enumerated steps, but aspects of the method 800 may include additional steps before, after, and in between the enumerated steps. In some respects, one or more of the enumerated steps may be omitted or performed in a different order.

The method 800 may comprise performing steps 702-712 of method 700 in FIG. 7. At step 802, if a user pause indication is received to pause an operation of the AI agent, the AI agent may pause at least one of the decomposing, the one or more sequential searches, generation of the one or more visualization elements, or the synthesizing at step 804. If no pause indication is received, the method 800 may continue performing the steps 702-712.

At step 808, the method may then storing a state of the AI agent. The stored state may comprise one or more of: (i) a plurality of discrete research objectives; (ii) retrieved search data from one or more sequential searches; (iii) a previously generated structured specification corresponding to one or more visualization elements; and (iv) a Transformer key-value (KV) cache associated with a LLM.

In one embodiment, at step 808, the AI agent determines a cache point in response to receipt of a pause command. The AI agent may capture state information corresponding to a particular agentic step (e.g., one of steps 702-712), including generated research objectives, results of a most recent sequential search, and/or a latest generated structured specification for visualization elements. The captured state may be stored in memory to enable subsequent resumption of the workflow.

If the pause command is received during a forward pass of the LLM (e.g., while generating a summary of search results from a second round of sequential search), the AI agent may selectively store persistent artifacts, such as the retrieved search results, while discarding one or more intermediate generation variables to reduce memory consumption. Upon resumption of the AI generation workflow, optionally in response to additional user input, the AI agent may recommence processing from a prior stable step, such as by performing an updated search and regenerating downstream outputs.

Alternatively, if the pause command is received during inference of the LLM, the AI agent may cache substantially all intermediate inference data, including Transformer KV cache values and other intermediate variables. Upon resumption, the AI agent may continue generation from a token position corresponding to the cached KV values and intermediate variables, thereby avoiding recomputation of prior tokens and preserving continuity of the generation process.

At step 810, the method may comprise receiving, from the user device (e.g., 104 in FIG. 1), a user feedback indicating a revision to an operation of the AI agent.

At step 812, the AI agent may determine a portion of the stored information to reused, based on which to generate a revised research plan in response to the user feedback. For example, the AI agent may where in the workflow the generation should re-start or resume in response to the user feedback, e.g., whether to initiate a new research workflow or revision of the ongoing workflow. If a new research project is determined, the previously stored state information of the prior research process including all LLM states may be discarded, and the newly provided input may be used to generate updated research objectives and associated outputs. If revision of the existing workflow is determined, the newly received input tokens are combined with the preserved session state and provided to the LLM as extended context, enabling continued autoregressive generation from the prior interruption point. In some embodiments, the AI agent may further permit multimodal feedback injection during the paused state, including user-provided charts, images, structured datasets (e.g., spreadsheet files), or other artifacts. Such multimodal inputs may be encoded into structured representations and incorporated into the resumed generation process to modify planning, analysis, visualization, or report synthesis operations. Therefore, the method 800 may then resume the operation of the AI agent in response to the user feedback based at least in part on the at least portion of the stored state of the AI agent.

In some embodiments, methods described herein are applicable in a variety of applications. For example, the task request (e.g., user query in FIG. 1) received by a neural network model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing methods, the neural network based artificial agent may improve technology in the respective technical field in healthcare and diagnostics, education and personalized learning, software development and code assistance, content creation, autonomous systems (such as autonomous driving, etc.), and/or the like.

For example, when the task request includes a query to identify an information technology (IT) anomaly relating to a usage of an IT component such as a network gateway, a router, an online printer, and/or the like, by performing methods 700-800 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of operating an artificial intelligence (AI) agent, comprising:
receiving, from a user device, a research task request;
decomposing, by a generative language model implemented at a server, the research task request into a plurality of discrete research objectives;
progressively performing, by the generative language model engaging a search tool, one or more sequential searches for each of the plurality of research objectives, wherein each of the one or more sequential searches is based on prior search results and a respective research objective;
generating, by the generative language model engaging one or more visualization application tools, one or more visualization elements based on search results from the one or more sequential searches;
synthesizing, by the generative language model engaging one or more document tools, the search results and the one or more visualization elements into a document file; and
transmitting the document file to the user device to be displayed as a downloadable file.

2. The method of claim 1, further comprising:
receiving, from the user device, a pause indication to pause an operation of the AI agent;
pausing at least one of the decomposing, the one or more sequential searches, generation of the one or more visualization elements, or the synthesizing; and
storing a state of the AI agent comprising one or more of:
the plurality of discrete research objectives;
retrieved search data;
previously generated structured specification for the one or more visualization elements; and
Transformer KV cache of the generative language model.

3. The method of claim 2, further comprising:
receiving, from the user device, a user feedback indicating a revision to an operation of the AI agent;
generating, by the generative language model, a revised research plan indicating at least a portion of the stored state to be reused; and
resuming the operation of the AI agent in response to the user feedback based at least in part on the at least portion of the stored state of the AI agent.

4. The method of claim 1, further comprising:
transmitting, to the user device, a text description of a workflow of the decomposing, the one or more sequential searches, generation of the one or more visualization elements, or the synthesizing to cause the text description of the workflow to be progressively displayed at a user interface on the user device.

5. The method of claim 1, wherein the generating the one or more visualization elements further comprises:
generating, by the generative language model, one or more structured data specification for the one or more visualization application tools to render the one or more structured data specification into the one or more visualization elements.

6. The method of claim 1, further comprising:
generating, by a text-to-image generation model, a cover image from the research task request.

7. The method of claim 6, wherein the synthesizing further comprises:
generating, by the generative language model, a structured document format combining a text section, the one or more visualization elements, and the cover image; and
converting the structured document format to the document file using a document rendering engine.

8. A system for operating an artificial intelligence (AI) agent, comprising:
a memory storing a plurality of processor-executable instructions;
one or more processor executing the plurality of processor-executable instructions processors to perform operations comprising:
receiving, from a user device, a research task request;
decomposing, by a generative language model implemented at a server, the research task request into a plurality of discrete research objectives;
progressively performing, by the generative language model engaging a search tool, one or more sequential searches for each of the plurality of research objectives, wherein each of the one or more sequential searches is based on prior search results and a respective research objective;
generating, by the generative language model engaging one or more visualization application tools, one or more visualization elements based on search results from the one or more sequential searches;
synthesizing, by the generative language model engaging one or more document tools, the search results and the one or more visualization elements into a document file; and
transmitting the document file to the user device to be displayed as a downloadable file.

9. The system of claim 8, wherein the operations further comprise:
receiving, from the user device, a pause indication to pause an operation of the AI agent;
pausing at least one of the decomposing, the one or more sequential searches, generation of the one or more visualization elements, or the synthesizing; and
storing a state of the AI agent comprising one or more of:
the plurality of discrete research objectives;
retrieved search data;
previously generated structured specification for the one or more visualization elements; and
Transformer KV cache of the generative language model.

10. The system of claim 9, wherein the operations further comprise:
receiving, from the user device, a user feedback indicating a revision to an operation of the AI agent;
generating, by the generative language model, a revised research plan indicating at least a portion of the stored state to be reused; and
resuming the operation of the AI agent in response to the user feedback based at least in part on the at least portion of the stored state of the AI agent.

11. The system of claim 9, wherein the operations further comprise:
transmitting, to the user device, a text description of a workflow of the decomposing, the one or more sequential searches, generation of the one or more visualization elements, or the synthesizing to cause the text description of the workflow to be progressively displayed at a user interface on the user device.

12. The system of claim 8, wherein the operation of generating the one or more visualization elements further comprises:
generating, by the generative language model, one or more structured data specification for the one or more visualization application tools to render the one or more structured data specification into the one or more visualization elements.

13. The system of claim 8, wherein the operations further comprise:
generating, by a text-to-image generation model, a cover image from the research task request.

14. The system of claim 13, wherein the operation of synthesizing further comprises:
generating, by the generative language model, a structured document format combining a text section, the one or more visualization elements, and the cover image; and
converting the structured document format to the document file using a document rendering engine.

15. A non-transitory processor-readable storage medium storing a plurality of processor-executable instructions for operating an artificial intelligence (AI) agent, the instructions being executed by one or more processors to perform operations comprising:
receiving, from a user device, a research task request;
decomposing, by a generative language model implemented at a server, the research task request into a plurality of discrete research objectives;
progressively performing, by the generative language model engaging a search tool, one or more sequential searches for each of the plurality of research objectives, wherein each of the one or more sequential searches is based on prior search results and a respective research objective;
generating, by the generative language model engaging one or more visualization application tools, one or more visualization elements based on search results from the one or more sequential searches;
synthesizing, by the generative language model engaging one or more document tools, the search results and the one or more visualization elements into a document file; and
transmitting the document file to the user device to be displayed as a downloadable file.

16. The non-transitory processor-readable storage medium of claim 15, wherein the operations further comprise:
receiving, from the user device, a pause indication to pause an operation of the AI agent;
pausing at least one of the decomposing, the one or more sequential searches, generation of the one or more visualization elements, or the synthesizing; and
storing a state of the AI agent comprising one or more of:
the plurality of discrete research objectives;
retrieved search data;
previously generated structured specification for the one or more visualization elements; and
Transformer KV cache of the generative language model.

17. The non-transitory processor-readable storage medium of claim 16, wherein the operations further comprise:
receiving, from the user device, a user feedback indicating a revision to an operation of the AI agent;
generating, by the generative language model, a revised research plan indicating at least a portion of the stored state to be reused; and
resuming the operation of the AI agent in response to the user feedback based at least in part on the at least portion of the stored state of the AI agent.

18. The non-transitory processor-readable storage medium of claim 15, wherein the operations further comprise:
transmitting, to the user device, a text description of a workflow of the decomposing, the one or more sequential searches, generation of the one or more visualization elements, or the synthesizing to cause the text description of the workflow to be progressively displayed at a user interface on the user device.

19. The non-transitory processor-readable storage medium of claim 15, wherein the operation of generating the one or more visualization elements further comprises:
generating, by the generative language model, one or more structured data specification for the one or more visualization application tools to render the one or more structured data specification into the one or more visualization elements.

20. The non-transitory processor-readable storage medium of claim 15, wherein the operations further comprise:
generating, by a text-to-image generation model, a cover image from the research task request;
generating, by the generative language model, a structured document format combining a text section, the one or more visualization elements, and the cover image; and
converting the structured document format to the document file using a document rendering engine.
